(19) United States
(12) Patent Application Publication
(10) Pub. No.: US 2011/0200005 A1
(43) Pub. Date: Aug. 18, 2011

(54) METHOD OF SUPPORTING MOBILITY USING SECURITY TUNNEL

(75) Inventors: Pyung Koo Park, Daejeon (KR); Sun Cheul Kim, Daejeon (KR); Sung Kee Noh, Daejeon (KR); Young Soo Shin, Daejeon (KR); Ho Sun Yoon, Daejeon (KR); Sung Back Hong, Daejeon (KR)

(73) Assignee: Electronics and Telecommunications Research Institute, Daejeon (KR)

(21) Appl. No.: 12/808,891

(22) PCT Filed: Nov. 28, 2008
(86) PCT No.: PCT/KR2008/007047

§ 371 Date: Jun. 17, 2010

(30) Foreign Application Priority Data
Dec. 17, 2007 (KR) 10-2007-0132815

(51) Int. Cl. H04W 36/32

(52) U.S. Cl. 370/331; 370/328

(57) ABSTRACT

Enclosed is a method of supporting mobility using a security tunnel. For the movement of a terminal in a local network and the movement of a terminal to an external network, an active tunnel and a standby tunnel are set to provide mobility to the terminal. When the local network moves, mobility for the local network is provided. The stability of a network is guaranteed using security connection.

### TECHNICAL FIELD

The present invention relates to a method of supporting mobility using a security tunnel, capable of supporting mobility through security connection between the inside and the outside of lower layers in different networks and of supporting the mobility of the lower layers.

The present invention is derived from researches performed as a part of the IT growth dynamic force technology development of the Ministry of Information and Communication and the Institute for Information Technology Advancement [subject management number: 2007-S-013-01 and subject title: development of a fixed-mobile convergence networking technology based on ALL IPv6].

### BACKGROUND ART

Recently, due to development of a radio network, researches of connecting a terminal to a plurality of networks so that the terminal can get services while moving the plurality of networks are actively performed. For example, researches are performed so that a terminal having a WiFi interface and a WiBro interface moves between two different networks to use radio networks.

A method of setting a tunnel using a terminal having a plurality of communication interfaces and of changing the tunnel in accordance with a radio link state to support mobility in a client/server based IPv6 movement structure is provided.

However, such a method has a problem in that it is difficult to guarantee the mobility of an IPv6 terminal in an IPv4 network when IP versions are different. In addition, it is possible to guarantee mobility in a predetermined network, however, it is not possible to guarantee mobility between external networks.

### DISCLOSURE OF INVENTION

### Technical Problem

In order to solve the above-described problems, it is an object of the present invention to provide a method of supporting mobility using a security tunnel, capable of providing mobility in a network and mobility to an external network while guaranteeing the security of a small network, of guaranteeing the security of a network using security connection, and of providing the mobility of a network so that it is possible to support mobility regardless of IP versions and that a network can move.

In order to achieve the objects, a method of supporting mobility using a security tunnel, comprises, when the terminal that receives services through a first tunnel moves in a first network comprising a mobility supporting apparatus for providing services to at least one terminal of the first network, the mobility supporting apparatus generating a second tunnel that is a standby tunnel in accordance with request of the terminal, comparing stability of the first tunnel of the terminal with stability of the second tunnel of the terminal, and, when the second tunnel is stable in comparison with the first tunnel, activating the second tunnel of the terminal and providing services to the terminal through the second tunnel.

### Technical Solution

A method of supporting mobility using a security tunnel of the first network in the second network, comprises, a mobility supporting apparatus connected to the first network that is a lower network of the second network, being connected to a mobility controlling server of the second network as a client, connecting the first network to the second network through a generated first tunnel to provide services, when the first network moves, requesting setup of a second tunnel that is a new tunnel for the first network to the mobility controlling server, and, when the second tunnel that is a standby tunnel is generated in response to the setup request and when the second tunnel becomes stable, activating the second tunnel and changing connection of the first network from the first tunnel to the second tunnel.

A method of supporting mobility of a terminal that moves between a first network and a second network in which the first network as a lower network is connected to the second network as an upper network, comprises, the terminal connected to the first network requesting tunnel setup for the second network in a state where the tunnel of the first network is maintained, changing connection setup to the tunnel of the second network before connection of the first network is cut off when the tunnel setup of the second network is completed, and, canceling the connection of the first network and transmitting and receiving data through the tunnel of the second network.

### Advantageous Effects

In the method of supporting mobility using a security tunnel according to the present invention, in an environment hierarchically constituted for a network core, it is possible to support mobility in a local network regardless of IP versions and it is possible for a terminal that moves to an external network to access a local network through security and authentication. Therefore, it is possible to continuously provide services and to improve convenience and efficiency in accordance with the use of services. In addition, since the mobility of a network is supported so that the network can move, it is possible to improve the services.

### BRIEF DESCRIPTION OF THE DRAWINGS

FIG. 1 illustrates that different networks are connected to each other according to an embodiment of the present invention;

FIG. 2 is a block diagram illustrating the structure of a mobility supporting apparatus according to an embodiment of the present invention;

FIG. 3 is a flowchart illustrating the flow of signals for supporting mobility according to an embodiment of the present invention;

FIG. 4 is a flowchart illustrating the operations of a mobility supporting method according to an embodiment of the present invention;

FIG. 5 illustrates the operations of mobility services according to an embodiment of the present invention;

FIG. 6 illustrates operations of supporting the mobility of a network according to an embodiment of the present invention; and

FIG. 7 illustrates operations in accordance with the movement of a terminal to an external global network in the movement of a local network according to an embodiment of the present invention.

### BEST MODE FOR CARRYING OUT THE INVENTION

Hereinafter, embodiments of the present invention will be described with reference to the accompanying drawings.

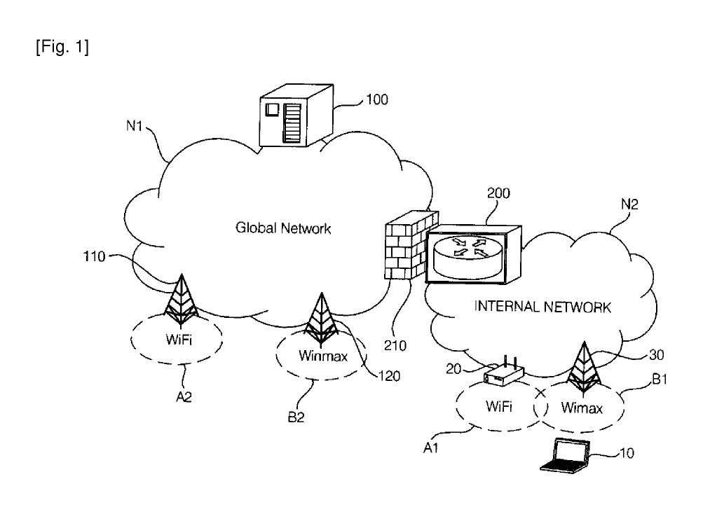

FIG. 1 illustrates that different networks are connected to each other according to an embodiment of the present invention.

Referring to FIG. 1, a mobility supporting apparatus 200 according to the present invention connects a global network N and a local network N2 to each other to provide mobility between different networks in accordance with the movement of a terminal.

The mobility supporting apparatus 200 is positioned under the global network N that is an upper network and an external network so that mobility and services are controlled by the mobility controlling server 100 of the global network N. At this time, the global network N as an IPv4 based core network includes at least one networks having different connection processes and standards. The mobility of the terminal connected to the global network is guaranteed by the mobility controlling server 100 by movement between different networks. For example, the terminal can consist of a WiFi radio LAN network or a WiMax radio LAN network and other radio networks.

The mobility supporting apparatus 200 is positioned on the local network N2 formed of a plurality of networks to control the mobility services of a terminal 10. A fire wall 210 is provided to support security connection when the terminal 10 is positioned in the global network N that is an external network to access the local network N2.

The terminal 10 is connected to the local network N2 through one of the WiFi radio LAN network A1 or the WiMax network B1 among a plurality of networks and is connected to the global network through the mobility supporting apparatus 200. At this time, the network can include other kinds of networks than the radio LAN (WiFi), the WiMax, and the WiBro and is not limited to the above.

At this time, the terminal 10 includes the WiFi connection interface and the WiMax connection interface so that the terminal 10 can be connected to the WiFi radio LAN network A1 and the WiMax network B2.

The terminal 10 is connected to the WiFi network or the WiMax network using one of the interfaces of the terminal to be connected to networks when a power source is driven. At this time, the terminal 10 activates a connection interface for one network in accordance with the signal magnitudes of the networks to be connected to the corresponding network. Then, an IP is set and an active interface is driven to transmit tunnel setup request and to register mobility supporting information in the mobility supporting apparatus 200 through the generated tunnel.

The terminal 10 can change the connected network during the transmission of data using the tunnel, tries to be connected to a new network to be authenticated, and then, moves to another network by setting an IP and by generating a new tunnel. At this time, the mobility supporting apparatus 200 provides mobility so that the transmission of data used by the terminal 10 is continuously maintained.

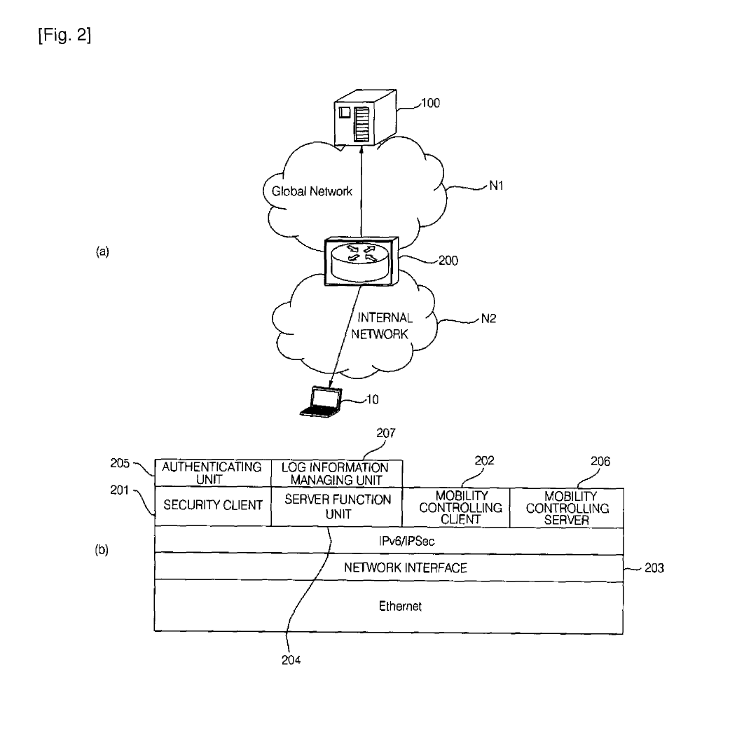

FIG. 2 is a block diagram illustrating the structure of a mobility supporting apparatus according to an embodiment of the present invention.

Referring to FIG. 2, the mobility supporting apparatus 200 as a hierarchical mobility supporting apparatus is a mobility service client for the mobility controlling server 100 of the global network N and operates as a mobility service server for supporting mobility between the local network N2 and the global network N.

The mobility supporting apparatus 200 drives the mobility controlling server 100 and a security client 201 for security to receive a security key and drives the mobility controlling client 202 to generate a tunnel. At this time, the tunnel is managed by a network interface 203.

The mobility supporting apparatus 200 performs authentication for the terminal 10 that requests mobility services through an authenticating unit 205, distributes a key, allows connection, and sets security through a server function unit 204, and drives a mobility controlling server 206 to support the mobility services. In addition, a log information managing unit 307 manages the mobility log information of the terminal 10 for highly reliable services. In particular, when the terminal 10 sets a tunnel from another network, the terminal 10 is authenticated based on the log information and information on connection allowance and security setup.

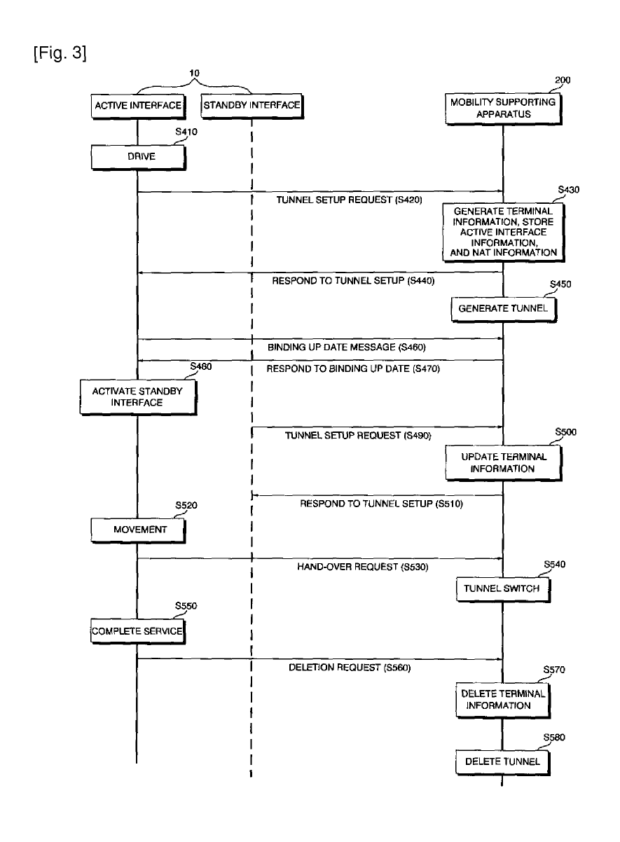

FIG. 3 is a flowchart illustrating the flow of signals for supporting mobility according to an embodiment of the present invention.

Referring to FIG. 3, the terminal 10 is driven (S410) so that the active interface is activated, the terminal 10 transmits a tunnel generation request message to the mobility supporting apparatus 200 through the active interface (S420).

The mobility supporting apparatus 200 that received the tunnel generation request message stores (S430) requested terminal information and transmits a response message (S440) to generate a tunnel (S450).

The terminal 10 that received the tunnel generation response message registers current position information in the mobility supporting apparatus 200 through the generated tunnel using a binding update message (S460) and the mobility supporting apparatus 200 transmits a binding update response message as a registration result to the terminal 10 to completely register services for the active interface.

In addition, when the terminal 10 is moved, after a standby tunnel is activated (S480), a standby tunnel is registered (S500) through a tunnel generation message (S490) and registration is confirmed by the tunnel generation response message (S510).

When the active interface and the standby interface are normally registered and the terminal 10 starts to move (S520), the terminal 10 measures the signals of the active interface and transmits a movement request binding update message (S530) when it is determined that the standby interface is stable in comparison with the active interface and the mobility supporting apparatus 200 switches over the active interface and the standby interface (S540). The terminal 10 completes services (S550) by a service completion binding update message (S560) and the mobility supporting server 200 deletes the corresponding terminal information (S570) and the tunnel (S580).

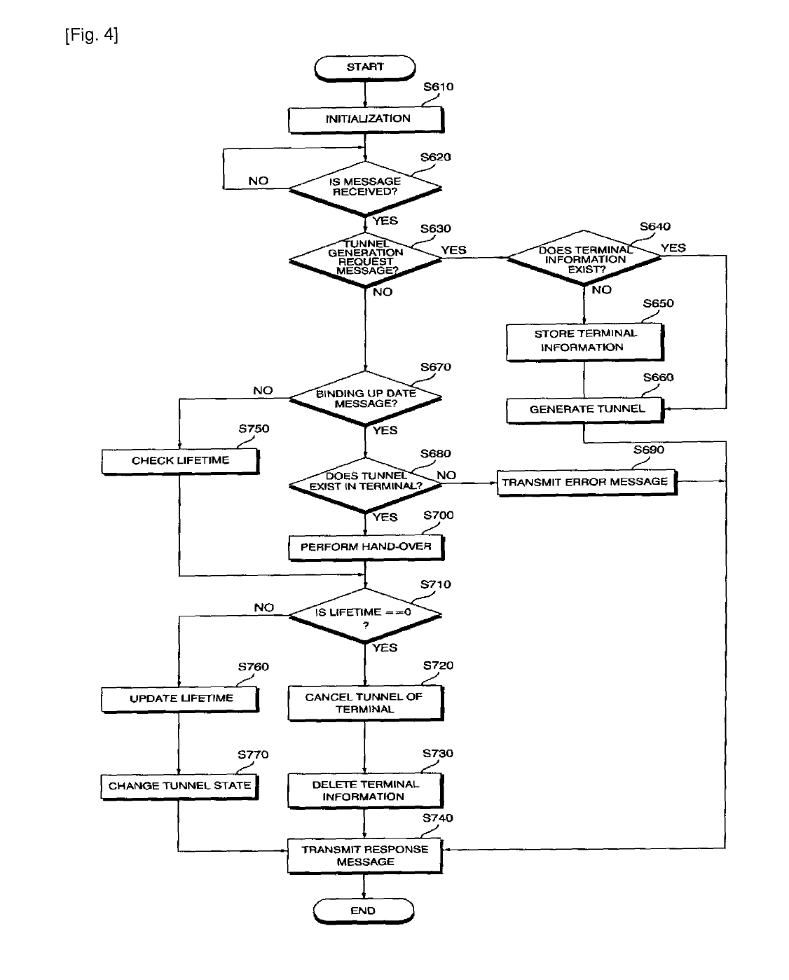

FIG. 4 is a flowchart illustrating the operations of a mobility supporting method according to an embodiment of the present invention.

Referring to FIG. 4, the mobility supporting apparatus 200 performs an initialization operation and initializes a protocol (S610).

When a message is received from the terminal (S620), it is determined whether the received message is a tunnel generation request message or a binding update message (S630).

At this time, when it is determined that the message is the tunnel generation request message, it is determined whether information on the terminal 10 exists (S640). When the information on the previously stored terminal 10 does not exist, cache entry is generated to store information on the terminal 10 (S650).

After the information on the terminal 10 exists or is newly stored, an active tunnel for the terminal 10 is generated in accordance with the kind of a work to be performed or a standby tunnel is generated S660 and a message for the generation of the tunnel is transmitted to the terminal (S740).

On the other hand, when the received message is the binding update message (S670), it is determined whether a generated tunnel exists for the terminal (S680). When the terminal does not exist or when the tunnel for the terminal does not exist, a response message for an error is transmitted (S690 and S740).

When the terminal and the tunnel for the terminal exist, a hand-over process for the terminal is performed (S700). A lifetime for the terminal is checked so that, when the lifetime is 0 (S710), the tunnel set for the terminal is removed (S720) and that, when the tunnel for the terminal does not exist, cache entry for the terminal is deleted (S730) to transmit a response message (S740).

On the other hand, when the lifetime of the terminal is not 0, the lifetime is refreshed (S760), the tunnel is changed from being active into being standby or from being standby into being active (S770) to transmit a response message (S740).

On the other hand, since information on the terminal 10 is updated at uniform intervals, lifetime of each terminal is periodically checked (S650) and the lifetime is refreshed as described above to change the state of the tunnel or to delete the tunnel (S710 to S770).

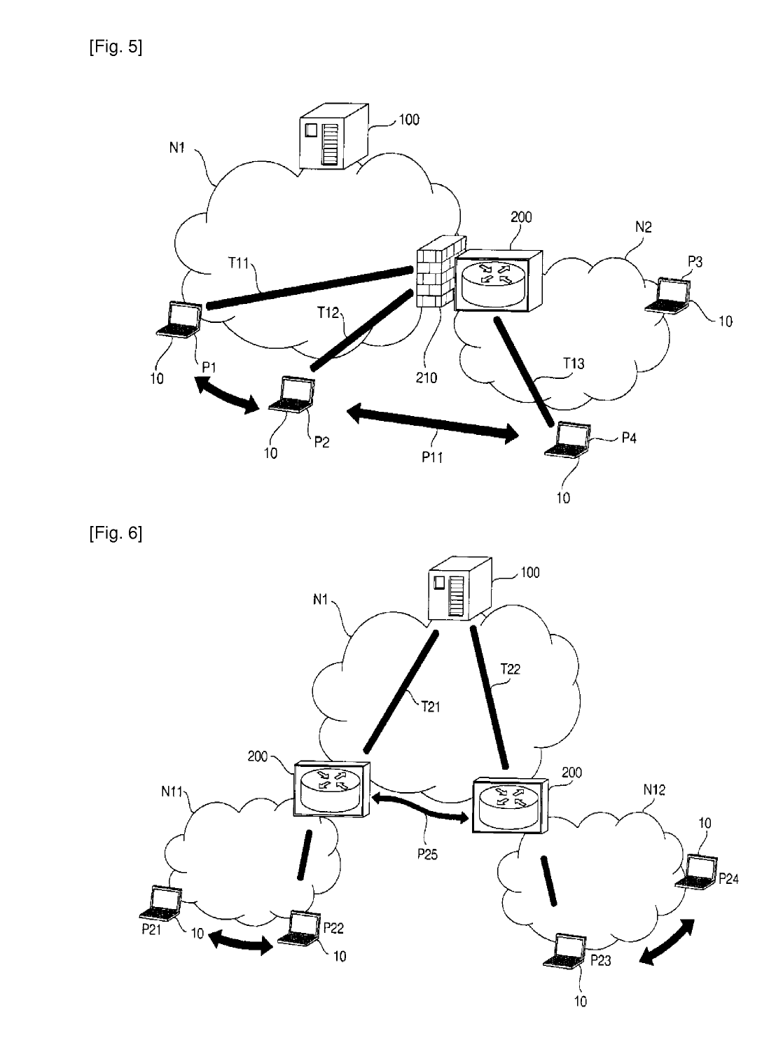

FIG. 5 illustrates the operations of mobility services according to an embodiment of the present invention.

Referring to FIG. 5, it is possible to perform a mobility P3-P4 of a terminal within a main network, that is, a local network, a mobility P1-P2 of a terminal within an external network, that is, a global network N1, and a mobility P11 of a terminal between the local network N2 and the external global network N1, and the mobility supporting apparatus supports the mobility of the terminal 10.

Here, the mobility within the local network is the same as the case of FIGS. 3 and 4 described above. The mobility supporting apparatus 200 communicates using an active tunnel T13 when the terminal 10 is present in the local network N2, and maintains the communication by creating a new active tunnel T12 when the terminal 10 moves into the external network N2.

The mobility supporting apparatus 200, in a case P11 of the terminal moving with maintaining the communication within the local network N2, maintains a continuous service such that a new standby tunnel T12 is pre-set while maintaining the active tunnel T13 with the local network N2 of the terminal 10 such that the original active tunnel T13 is changed into the pre-set standby tunnel T12 before the original active tunnel T13 is cut off.

Meanwhile, when a service request is received from the external global network N1, the mobility supporting apparatus 200 performs security and authentication of the terminal 10 requesting the service to guarantee the stability of service.

When a new movement P2-P1 of the terminal 10 occurs in the external global network N1, a new standby tunnel T11 is preset to perform authentication, and the prior active tunnel T12 is exchanged by the new standby tunnel T11.

FIG. 6 illustrates operations of supporting the mobility of a network according to an embodiment of the present invention.

Referring to FIG. 6, the mobility supporting apparatus 200 supports the mobility when the local network N12 itself moves.

For example, if a local network is built in a train or a motor vehicle, the local network itself moves (P25), in this case, the mobility supporting apparatus 200 supports the mobility of the local network N12.

The mobility supporting apparatus 200 creates a tunnel as a mobility controlling client in the mobility controlling server 100, and supports the mobility service of the terminal 10 located in the local network N2.

When the local network N12 moves, the standby tunnel is created (T21) as the above-mentioned mobility controlling client, the current tunnel T22 is changed into the new tunnel (T21) to guarantee the service continuity (N12->N11) of the local network. In this case, although the local network is distinguished by a pre-movement N12 and a post-movement N11, it is noted that the location of the network only is changed but the local network is same.

Here, the terminal 10 is guaranteed with the mobility when moving P21-P22 and P23-P24 using the tunnel within the local network N12 regardless of the movement of the local network N12.

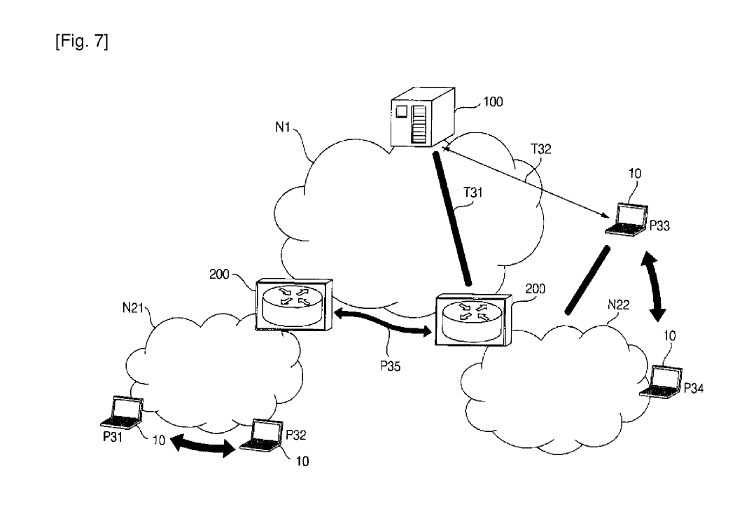

FIG. 7 illustrates operations in accordance with the movement of a terminal to an external global network in the movement of a local network according to an embodiment of the present invention.

Referring to FIG. 7, the mobility supporting apparatus 200 provides the mobility to the terminal 10 when the terminal 10 of the local network moved into the external global network N1 (P33-P34) while the local network moves (P35) as illustrated in FIG. 6.

In the mobility supporting apparatus 200, during the movement P35 of the local network, the terminal 10 moved into the external global network N1 acquires care-of address (hereinafter, referred to as CoA) for transmitting a message for demanding to create a tunnel changed due to the movement of a layer mobility supporting apparatus, and the tunnel is set from the external network to the local network N21 to which the local network has moved. In this case, although the local network is distinguished by a pre-movement N22 and a post-movement N21, it is noted that the location of the network only is changed but the local network is same.

Since the mobility supporting apparatus 200 works as a client of the mobility controlling server 100 of the global network N1, the tunnel is created by the mobility controlling server 100 and a new tunnel is created along with the movement P35 of the local network.

The mobility supporting apparatus 200 acquires a new CoA, and the terminal 10 moved (p34-P33) from the local network to the external global network cannot recognize the change CoA. However, since the mobility controlling server 100 manages the CoA of the mobility supporting apparatus as a client of the mobility controlling server 100 own, the terminal present in the external global network acquires a new CoA using the unique address, home address (HoA) of own mobility supporting apparatus 200 from the mobility controlling server 100. The message for demanding to create a tunnel is transmitted to the mobility supporting apparatus 100 through the acquired CoA as described above so that the tunnel is created. At that time, the terminal 10 acquires address by querying the CoA with respect to the unique address, HoA of the mobility supporting apparatus 200 to the mobility controlling server 100, and request to set the tunnel as described above.

Therefore, the method of supporting mobility using a secure tunnel not only supports mobility for the movement of the terminal within a local network and for the movement of the terminal between the local network and the external global network, but also provides mobility for the movement of the local network and the movement of the terminal during the movement of the local network, so that continuity of the service can be provided to the terminal.

As described above, the method of supporting mobility using a secure tunnel according to the present invention has been described with reference to the embodiment shown in the drawings, these are merely illustrative, and those skilled in the art will understand that various modifications and equivalent other embodiments of the present invention are possible. Consequently, the true technical protective scope of the present invention must be determined based on the technical spirit of the appended claims.

### INDUSTRIAL APPLICABILITY

According to the present invention, using a standby tunnel and an active tunnel, it is possible to support mobility of a terminal within a local network regardless of IP versions and it is possible to support mobility during the movement of the local network. Therefore, it is possible to continuously provide services and to improve convenience and efficiency in accordance with the use of services.

1. A method of supporting mobility using a security tunnel, comprising:
when the terminal that receives services through a first tunnel moves in a first network comprising a mobility supporting apparatus for providing services to at least one terminal of the first network, the mobility supporting apparatus generating a second tunnel that is a standby tunnel in accordance with request of the terminal;
comparing stability of the first tunnel of the terminal with stability of the second tunnel of the terminal; and
when the second tunnel is stable in comparison with the first tunnel, activating the second tunnel of the terminal and providing services to the terminal through the second tunnel.

2. The method of claim 1, further comprising registering and storing information regarding the terminal when the second tunnel is requested to be generated.

3. The method of claim 1, further comprising, when the terminal moves from the first network to a second network that is an upper network, requesting setup of a third tunnel that is a standby tunnel to a mobility controlling server of the second network as a client; and
setting the third tunnel for the terminal in response to the request.

4. The method of claim 3, wherein, when a binding update message is received from the terminal to the mobility supporting apparatus in response to movement of the terminal, activating the third tunnel of the terminal; and
performing handover for the terminal from the first network to the second network using the third tunnel.

5. The method of claim 3, further comprising, when the terminal is handed over to the second network, the mobility supporting apparatus canceling the first tunnel and the second tunnel for the terminal and deleting information regarding the terminal.

6. A method of supporting mobility using a security tunnel of the first network in the second network, comprising:
a mobility supporting apparatus connected to the first network that is a lower network of the second network, being connected to a mobility controlling server of the second network as a client, connecting the first network to the second network through a generated first tunnel to provide services;
when the first network moves, requesting setup of a second tunnel that is a new tunnel for the first network to the mobility controlling server; and
when the second tunnel that is a standby tunnel is generated in response to the setup request and when the second tunnel becomes stable, activating the second tunnel and changing connection of the first network from the first tunnel to the second tunnel.

7. The method of claim 6, further comprising, when the terminal connected to the first network moves in the first network during the movement of the first network, the mobility supporting apparatus generating a third tunnel in the terminal so that the terminal can transmit and receive data through the third tunnel in accordance with the movement of the terminal.

8. The method of claim 6, further comprising, when the terminal connected to the first network moves to the second network during the movement of the first network, the mobility supporting apparatus setting a fourth tunnel of the terminal for the second network and performing the hand-over process of the terminal using the fourth tunnel; and
when the hand-over of the terminal is completed, canceling the tunnel of the terminal for the first network and deleting information on the terminal.

9. The method of claim 8, further comprising:
receiving tunnel setup request from the terminal connected to the second network to the mobility supporting apparatus; and
performing security and authentication for the terminal and generating a fifth tunnel for the terminal when the authentication is completed.

10. A method of supporting mobility of a terminal that moves between a first network and a second network in which the first network as a lower network is connected to the second network as an upper network, comprising:
the terminal connected to the first network requesting tunnel setup for the second network in a state where the tunnel of the first network is maintained;
changing connection setup to the tunnel of the second network before connection of the first network is cut off when the tunnel setup of the second network is completed; and
canceling the connection of the first network and transmitting and receiving data through the tunnel of the second network.

11. The method of claim 10, further comprising, when the terminal removes from the second network to the first network,
requesting a care of address (CoA) of the first network to a mobility controlling server of the second network;
requesting the generation of a tunnel to the first network using the CoA received from the mobility controlling server; and
performing handover from the second network to the first network using a standby tunnel generated in the first network.
